(19) United States
(12) Patent Application Publication
(10) Pub. No.: US 2003/0229530 A1
(43) Pub. Date: Dec. 11, 2003

(54) Methods for production forecasting and ordering

(76) Inventor: Chih-Chung Lai, Santa Clara, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/330,844

(22) Filed: Dec. 26, 2002

(30) Foreign Application Priority Data
Jun. 6, 2002 (TW) 91112170

(51) Int. Cl. G06F 17/60

(52) U.S. Cl. 705/8

(57) ABSTRACT

Methods for production forecasting and ordering are implemented using a production forecast and ordering system (10), which includes a database server (101) for receiving and processing data on production forecasting and ordering, a database (102) for storing received data, and a plurality of computer terminals (103) for users to access data stored in the database. The production forecast and ordering system transforms data received from a customer system (12) into a format that an internal enterprise resource planning (ERP) system (16) uses. When receiving component requirement information and supplier information from the ERP system, the production forecast and ordering system generates component planning sheets, and send the component planning sheets to relevant supplier systems (13). After receiving response information from the supplier systems, the production forecast and ordering system automatically integrates the received information with data stored in the database, and sends the integrated data to the ERP system.

### BACKGROUND OF INVENTION

1. Field of the Invention

The present invention relates to methods for production forecasting and ordering by way of data interchange, and particularly to methods which automatically transform different data formats and integrate data sent from multiple data sources.

2. Description of Related Art

Within the computer, consumer electronic products communication industry (the so-called “3C” industry), the process whereby a product progresses from production to sale can be viewed as a product supply chain. The major role players in such chain include the brand owner, component supplier, manufacturer, carrier, and retailer. These players are respectively responsible for product ordering, component supply, product manufacturing, component and product transportation, and product sales. This supply chain flows from product ordering through product sale, and the swiftness and smoothness of the flow benefits every player along the way. Product ordering by the brand owner is the driving force of the supply chain, therefore a speedy and smooth ordering procedure is vital. Direct role players at this end of the supply chain include the brand owner, component supplier, manufacturer, and carrier. How to coordinate these roles for the purpose of achieving a fast and smooth ordering procedure has always been an important concern in the 3C industry.

One way to address the above problem is to divide the ordering procedure into a forecast ordering procedure and a production ordering procedure. Forecast ordering procedure can enable the brand owner to make a forecast order, assess the component supplier's and manufacturer's capabilities to fulfill the forecast order, and use the forecast order as a springboard for the production ordering procedure. This way, over-production and under-production can be avoided.

The forecast ordering and production ordering procedures can be performed by way of Electronic Document Interchange (EDI) through a network that links the brand owner's computer system, the component supplier's computer system and manufacturer's computer system. However, each of these systems may use different electronic data formats. A system and method that can speedily integrate different electronic data formats is needed in order to increase the efficiency of ordering procedures.

U.S. Pat. No. 5,991,732 illustrates a method that maintains the smoothness of the supply chain by the use of a computer system that assists the role players involved in the supply chain. The method uses customer demand to derive a sales forecast, and uses the sales forecast as the basis for forecast ordering. The method essentially uses sales information as the foundation for forecast ordering. However, the method does not address production ordering.

Accordingly, what is needed is a method which can overcome the abovementioned problems and satisfy the abovementioned need.

### SUMMARY OF THE INVENTION

One objective of the present invention is to provide a method for implementing production forecasting which automatically transforms different data formats that are used by different enterprises and integrates data from different data sources.

Another objective of the present invention is to provide a method for implementing ordering procedures by automatically transforming different data formats that are used by different enterprises and integrating data from different data sources.

To achieve the first above-mentioned object, a method of the present invention for production forecasting and ordering comprises the following steps: receiving a forecast purchase order via a network; transforming a data format of the forecast purchase order, and sending the transformed forecast purchase order to a management information system; receiving a forecast purchase order response from the management information system; transforming a data format of the forecast purchase order response, and sending the transformed forecast purchase order response to a customer system; receiving component requirement and supplier information from the management information system; generating component planning sheets based on the component requirement and supplier information, and sending the component planning sheets to relevant supplier systems; receiving component planning sheet responses from the supplier systems; transforming at least one data format of the component planning sheet responses; integrating component data that are retrieved from the transformed component planning sheet responses and from a database; and sending the integrated component data to the management information system.

To achieve the second above-mentioned object, a further method of the present invention for production forecasting and ordering comprises the following steps: receiving a purchase order via a network; transforming a data format of the purchase order, and sending the transformed purchase order to a management information system; receiving a sales order from the management information system; transforming a data format of the sales order, and sending the transformed sales order to a customer system; receiving a component purchase order from the management information system; transforming a data format of the component purchase order, and sending corresponding transformed component purchase orders to relevant supplier systems; receiving component sales orders from the supplier systems; transforming at least one data format of the component sales orders, and sending a corresponding transformed component sales order to the management information system; receiving a shipping advice from the management information system; transforming a data format of the shipping advice, and sending corresponding transformed shipping advices to relevant carrier systems; receiving shipping advice confirmations from the carrier systems; and transforming at least one data format of the shipping advice confirmations, and sending a corresponding transformed shipping advice confirmation to the management information system.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a view of hardware infrastructure for implementing a method for production forecasting and ordering in accordance with the present invention;

FIG. 2 is a detailed illustration of function modules of a database server of the hardware infrastructure of FIG. 1;

FIG. 3 is a schematic diagram of data interchange related to production forecasting in accordance with the present invention;

FIG. 4 is a schematic diagram of data interchange related to ordering procedures in accordance with the present invention;

FIG. 5 is a flowchart for implementing production forecasting in accordance with the present invention; and

FIG. 6 is a flowchart for implementing ordering procedures in accordance with the present invention.

### DETAILED DESCRIPTION OF THE INVENTION

Reference will now be made to the drawing figures to describe the present invention in detail.

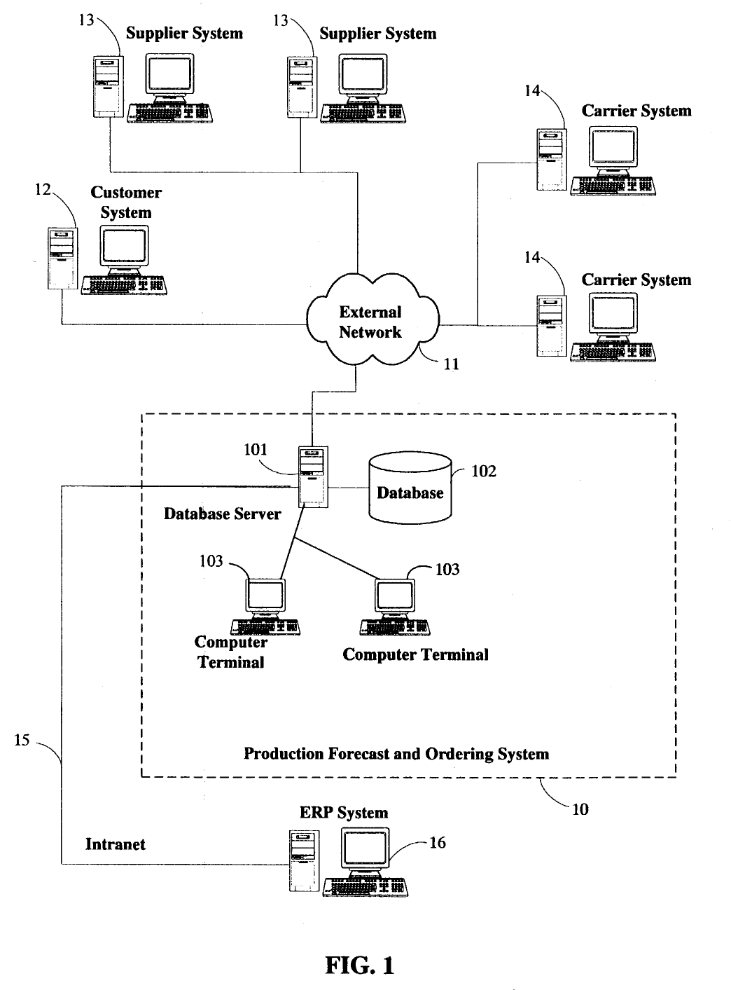

FIG. 1 is a view of hardware infrastructure for implementing a method for production forecasting and ordering in accordance with the present invention. The hardware infrastructure includes a production forecast and ordering system 10. The production forecast and ordering system 10 comprises a database server 101 and a database 102. The production forecast and ordering system 10 is connected to a customer system 12, multiple supplier systems 13 and multiple carrier systems 14 by an external network 11 that can be the Internet or an extranet. An Enterprise Resource Planning (ERP) system 16 is connected to the production forecast and ordering system 10 via an intranet 15 that can be a local area network (LAN). The ERP system 16 is an internal management information system (MIS) of an enterprise that uses the production forecast and ordering system 10. The database server 101 receives and processes data from the customer system 12, the supplier systems 13, the carrier systems 14 and the ERP system 16. The processed data are stored in the database 102. A user of the customer system 12 can be an employee of a customer's enterprise. A user of the supplier system 14 can be an employee of a supplier's enterprise. A user of the carrier system 13 can be an employee of a carrier's enterprise. A plurality of computer terminals 103 is connected to the database server 101, for users to search for data stored in the database 102.

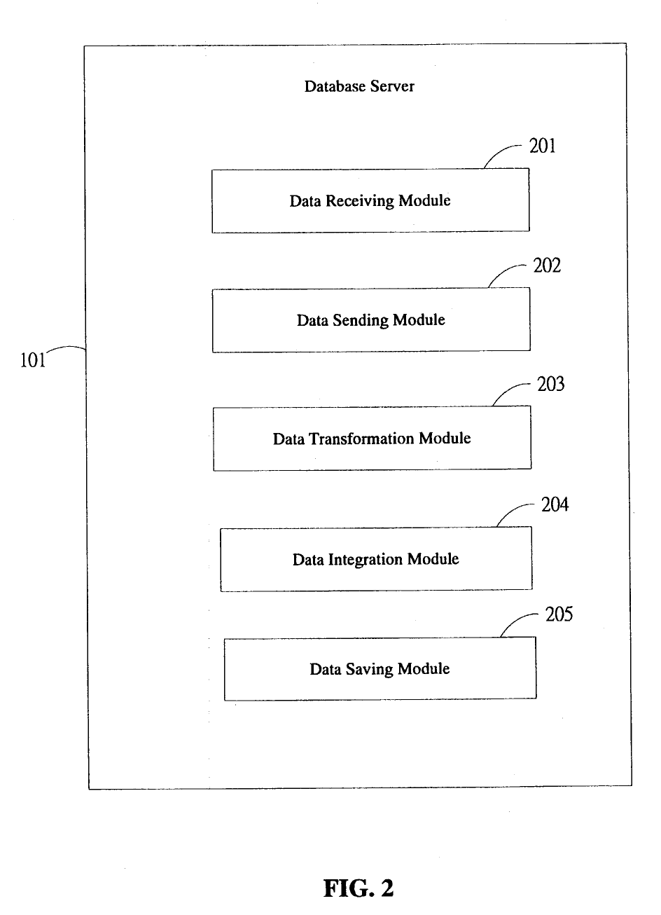

FIG. 2 is a detailed illustration of function modules of the database server 101 of the production forecast and ordering system 10. The database server 101 includes: a data receiving module 201 for receiving data from the customer system 12, the supplier systems 14, the carrier systems 13 and the ERP system 16; a data sending module 202 for sending data to the customer system 12, the supplier systems 13, the carrier systems 14 and the ERP system 16; a data transformation module 203 for transforming a format of data; a data integration module 204 for integrating data from a same data source; and a data saving module 205 for saving processed data. The data formats that can be transformed include Electronic Data Interchange (EDI) format, Hypertext Markup Language (HTML) format, E-mail format, and Extensible Markup Language (XML) format. The data integrating module 204 integrates received data with data stored in the database 102. For example, when the database server 101 receives data from a supplier “X” on confirmation of shipment of 1,000 pieces of cargo “A”, the data integration module 204 automatically identifies supplier “X” data in the database 102 and integrates the received data with the supplier “X” data in the database 102. The 1,000 pieces of cargo “A” is added in the quantity of cargo “A” of the supplier “X” in the database 102.

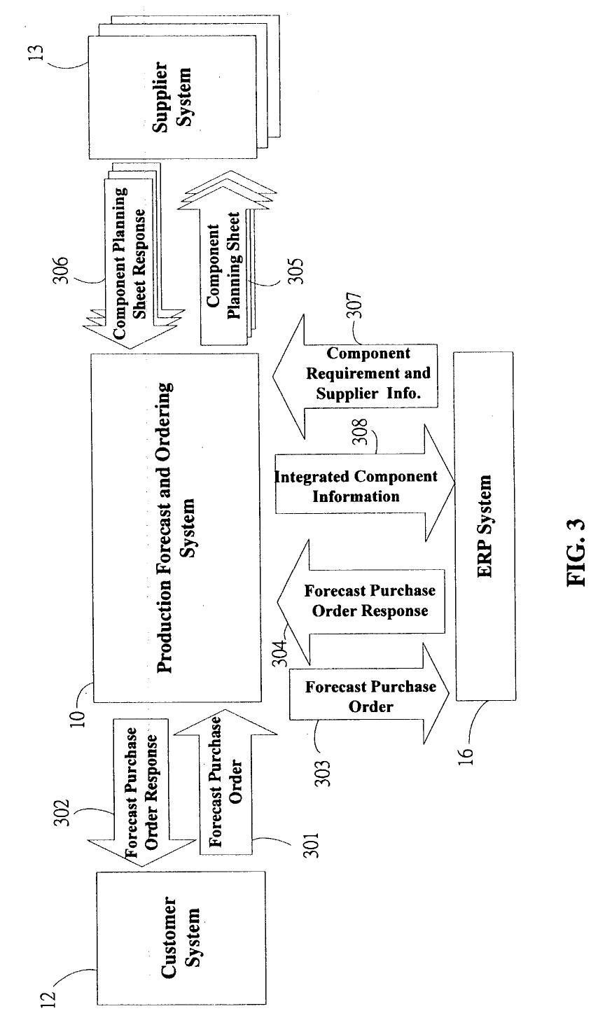

FIG. 3 is a schematic diagram showing data interchange related to production forecasting using the production forecast and ordering system 10. Firstly, the customer system 12 sends a forecast purchase order 301 to the production forecast and ordering system 10, which transforms a data format of the forecast purchase order 301 into a format that the ERP system 16 uses. The transformed forecast purchase order 303 is sent to the ERP system 16, which then sends a forecast purchase order response 304 back to the production forecast and ordering system 10 to confirm acceptance of the forecast purchase order 301. The forecast purchase order response 304 is transformed in the production forecast and ordering system 10 into a transformed forecast purchase order response 302, which is then sent to the customer system 12. Thereafter, the ERP system 16 sends component requirement and relevant supplier information 307 to the production forecast and ordering system 10, based on the forecast purchase order 301. The production forecast and ordering system 10 receives and processes the component requirement and supplier information 307, generates component planning sheets 305, and sends the component planning sheets 305 to relevant supplier systems 13. The supplier systems 13 send component planning sheet responses 306 back to the production forecast and ordering system 10. The production forecast and ordering system 10 transforms data formats of the component planning sheet responses 306, integrates data retrieved from the transformed component planning sheet responses 306 and from the database 102, generates integrated component information 308, and sends the integrated component information 308 to the ERP system 16.

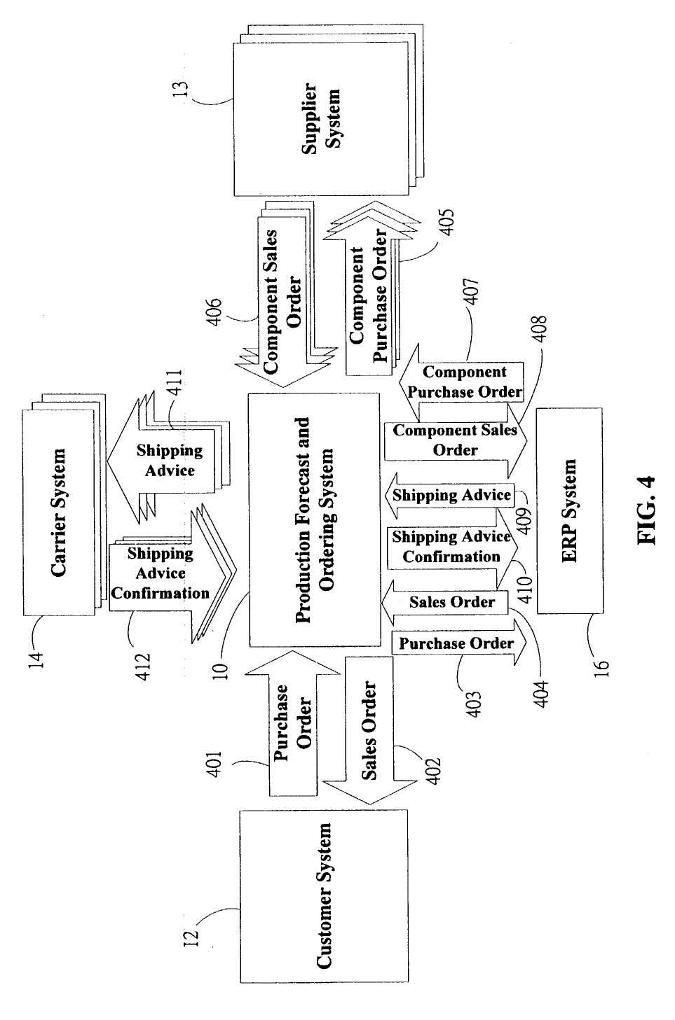

FIG. 4 is a schematic diagram of data interchange related to ordering procedures using the production forecast and ordering system 10. Firstly, the customer system 12 sends a purchase order 401 to the production forecast and ordering system 10, which transforms a data format of the purchase order 401 into a format that the ERP system 16 uses. The transformed purchase order 403 is sent to the ERP system 16, which then sends a sales order 404 back to the production forecast and ordering system 10 to confirm acceptance of the purchase order 401. The sales order 404 is transformed in the production forecast and ordering system 10 into a transformed sales order 402, which is then sent to the customer system 12. Thereafter, the ERP system 16 sends a component purchase order 407 to the production forecast and ordering system 10, based on the purchase order 401. The production forecast and ordering system 10 transforms a data format of the component purchase order 407, identifies relevant suppliers, generates corresponding component purchase orders 405, and sends the component purchase orders 405 to relevant supplier systems 13. The supplier systems 13 send back component sales orders 406 to the production forecast and ordering system 10. The production forecast and ordering system 10 transforms the component sales orders 406 into a corresponding component sales order 408, which is then sent to the ERP system 16. After that, the ERP system 16 sends a shipping advice 409 to the production forecast and ordering system 10 according to the received purchase order 401. The production forecast and ordering system 10 transforms a data format of the shipping advice 409, and sends the transformed shipping advice 411 to the carrier system 14. The carrier system 14 sends a shipping advice confirmation 412 back to the production forecast and ordering system 10. The production forecast and ordering system 10 transforms the shipping advice confirmation 412 into a transformed shipping advice confirmation 410, which is then sent to the ERP system 16.

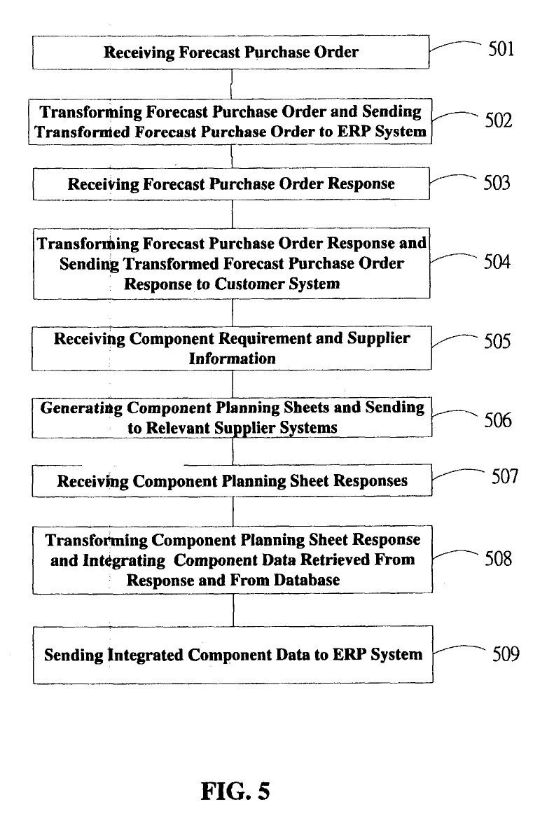

FIG. 5 is a flowchart for implementing production forecasting using the production forecast and ordering system 10. The process of production forecasting comprises the following steps:

(a) receiving a forecast purchase order 301 from the customer system 12 through the external network 11. (Step 501)

(b) transforming a data format of the forecast purchase order 301, and sending the transformed forecast purchase order 303 to the ERP system 16, the transformed forecast purchase order 303 being stored in the database 102. (Step 502)

(c) receiving a forecast purchase order response 304 from the ERP system 16, the forecast purchase order response being stored in the database 102. (Step 503)

(d) transforming a data format of the forecast purchase order response 303, and sending the transformed forecast purchase order response 302 to the customer system 12. (Step 504)

(e) receiving component requirement and supplier information 307 from the ERP system 16 (Step 505). Component requirements are calculated according to the received forecast purchase order 303 and available component inventory. The supplier information includes names of suppliers from whom the required components are purchased.

(f) generating component planning sheets 305, and sending the component planning sheets 305 to relevant supplier systems 14 according to the component requirement and supplier information 307 (Step 506). A data format of the component planning sheets 305 is a format that the designated supplier systems 14 use.

(g) receiving component planning sheet responses 306 from the supplier systems 14. (Step 507)

(h) transforming data formats of the component planning sheet responses 306, and integrating component data that are retrieved from the component planning sheet responses 306 and from the database 102 (Step 508). The integrated component data show quantities of all available components that include components available from inventory and components available from suppliers. The integrated component data are stored in the database 102.

(i) sending the integrated component data to the ERP system 16 through the intranet 15. (Step 509)

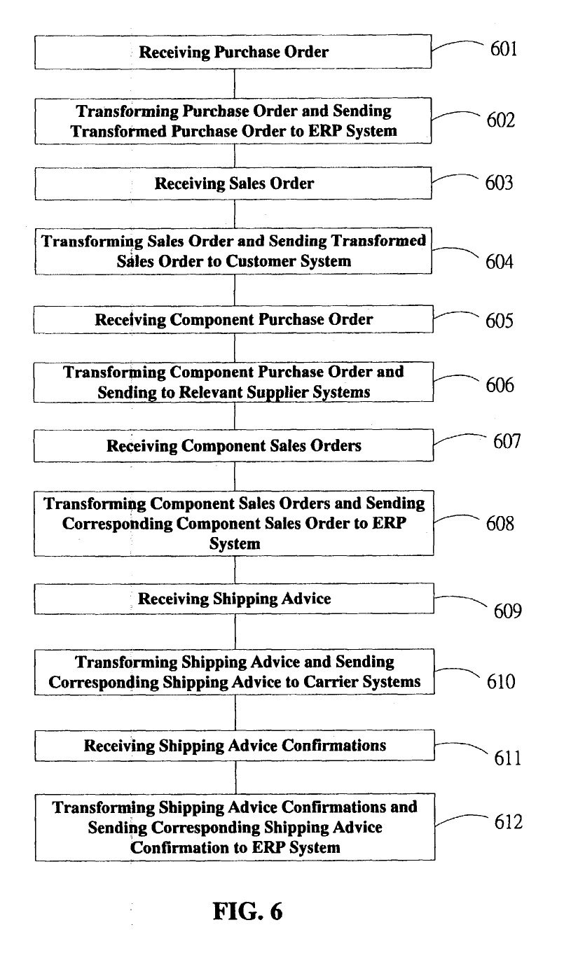

FIG. 6 is a flowchart for implementing ordering procedures using the production forecast and ordering system 10. The ordering procedures comprise the following steps:

(a) receiving a purchase order 401 from the customer system 12 through the external network 11. (Step 601)

(b) transforming a data format of the purchase order 401, and sending the transformed purchase order 403 to the ERP system 16, the transformed forecast purchase order 403 being stored in the database 102. (Step 602)

(c) receiving a sales order 404 from the ERP system 16, the sales order 404 being stored in the database 102. (Step 603)

(d) transforming a data format of the sales order 404, and sending the transformed sales order 404 to the customer system 12. (Step 604)

(e) receiving a component purchase order 407 from the ERP system 16. (Step 605).

(f) transforming a data format of the component purchase order 407, and sending corresponding transformed component purchase orders 405 to relevant supplier systems 14. (Step 606)

(g) receiving component sales orders 406 from the supplier systems 14. (Step 607).

(h) transforming data formats of the component sales orders 406, and sending a corresponding transformed component sales order 408 to the ERP system 16, the transformed component sales order 408 being stored in the database 102. (Step 608)

(i) receiving a shipping advice 409 from the ERP system 16 via the intranet 15. (Step 609)

(j) transforming a data format of the shipping advice 409, and sending corresponding transformed shipping advices 411 to relevant carrier systems 13 via the external network 11. (Step 610)

(k) receiving shipping advice confirmations 412 from the carrier systems 16. (Step 611)

(l) transforming data formats of the shipping advice confirmations 412, and sending a corresponding transformed shipping advice confirmation 410 to the ERP system 16 via the intranet 15. (Step 612).

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claim is:

1. A method for production forecasting and ordering, the method comprising the following steps:
receiving a forecast purchase order via a network;
transforming a data format of the forecast purchase, order and sending the transformed forecast purchase order to a management information system;
receiving component requirement and supplier information from the management information system;
generating component planning sheets based on the component requirement and supplier information, and sending the component planning sheets to relevant supplier systems;
receiving component planning sheet responses from the supplier systems;
integrating component data that are retrieved from the component planning sheet responses and from a database; and
sending the integrated component data to the management information system.

2. The method as described in claim 1, further comprising the step of:
receiving a forecast purchase order response from the management information system.

3. The method as described in claim 2, further comprising the step of:
transforming a data format of the forecast purchase order response, and sending the transformed forecast purchase order response to a customer system.

4. The method as described in claim 1, wherein component requirements are calculated according to the forecast purchase order and available component inventory.

5. The method as described in claim 1, wherein the supplier information includes names of suppliers from whom required components are purchased.

6. A method for production forecast and ordering, the method comprising the following steps:
receiving a forecast purchase order via a network;
transforming a data format of the forecast purchase order, and sending the transformed forecast purchase order to a management information system;
receiving a forecast purchase order response from the management information system;
transforming a data format of the forecast purchase order response, and sending the transformed forecast purchase order response to a customer system;
receiving component requirement and supplier information from the management information system;
generating component planning sheets based on the component requirement and supplier information, and sending the component planning sheets to relevant supplier systems;
receiving component planning sheet responses from the supplier systems;
transforming at least one data format of the component planning sheet responses;
integrating component data that are retrieved from the transformed component planning sheet responses and from a database; and
sending the integrated component data to the management information system.

7. A method for production forecast and ordering, the method comprising the following steps:
receiving a purchase order via a network;
transforming a data format of the purchase order, and sending the transformed purchase order to a management information system;
receiving a sales order from the management information system;
transforming a data format of the sales order, and sending the transformed sales order to a customer system;
receiving a component purchase order from the internal management information system;
transforming a data format of the component purchase order, and sending corresponding transformed component purchase orders to relevant supplier systems;
receiving component sales orders from the supplier systems;
transforming at least one data format of the component sales orders, and sending a corresponding transformed component sales order to the management information system;
receiving a shipping advice from the management information system;
transforming a data format of the shipping advice, and sending corresponding transformed shipping advices to relevant carrier systems;
receiving shipping advice confirmations from the carrier systems; and
transforming at least one data format of the shipping advice confirmations, and sending a corresponding transformed shipping advice confirmation to the management information system.

8. A method of integrating production and ordering, comprising steps of:
receiving a forecast purchase order;
sending said forecast purchase order to a management information system;
obtaining component requirement and supplier information from the management information system;
sending a forecast component purchase order to a component supplier;
obtaining a response from the supplier regarding said forecast component purchase order;
sending a forecast shipping advice to a carrier including forecast component shipment or final product shipment;
obtaining a response from the carrier regarding the forecast shipping advice;
integrating information from the management information system, the responses of the component supplier and the carrier; and
sending said integrated information to the client for initial confirmation.
